(19) United States
(12) Patent Application Publication
(10) Pub. No.: US 2008/0167996 A1
(43) Pub. Date: Jul. 10, 2008

(54) Systems and methods for printing draft checks

(76) Inventors: Amy Broome, Cornelius, NC (US); John Tupper, Clover, SC (US); Patsy Sutton, Lancaster, SC (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/651,278

(22) Filed: Jan. 9, 2007

(51) Int. Cl. G06Q 40/00; H04L 9/00

(52) U.S. Cl. 705/64; 705/35; 705/45

(57) ABSTRACT

A method for printing drafts includes: communicating between a second computer corresponding to a financial institution and a first computer corresponding to a company that has a financial account with the financial institution, wherein the first computer is located at the company's premises and remotely from the second computer; and printing a draft check by a printer that is coupled to the first computer responsive to the communicating between the first and second computers, wherein the draft check is payable from a financial account that the company has with the financial institution.

### BACKGROUND OF THE INVENTION

Financial institutions and their customers desire convenient systems and methods that enable the financial institution customers to print draft checks at the customers' premises. A previous method of enabling a customer to print a draft check at a customer premises involved mailing a copy of software to be installed at the customer premises to enable the printing of draft checks. One problem with this method is that financial institutions and their customer were unable to closely monitor and control the printing of draft checks. Furthermore, the customer accounts were not debited immediately after the printing of the draft checks. Therefore, there exists a need for improved systems and methods that enable customers of financial institutions to print draft checks.

### SUMMARY

Systems and methods for printing draft checks are provided. An embodiment of such a method includes: communicating between a second computer corresponding to a financial institution and a first computer corresponding to a company that has a financial account with the financial institution, wherein the first computer is located at the company's premises and remotely from the second computer; and printing a draft check by a printer that is coupled to the first computer responsive to the communicating between the first and second computers, wherein the draft check is payable from a financial account that the company has with the financial institution.

An embodiment of a system for printing drafts includes: a first computer having memory and software stored in the memory, the software being configured to enable communicating information corresponding to a draft check with a second computer; wherein the second computer corresponds to a financial institution and the first computer corresponds to a company that is a customer of the financial institution, and the first computer is located at a premises of the company and remotely from the second computer; and wherein the software is configured to enable printing of the draft check by a printer at the premises responsive to communication between the first and second computers.

An embodiment of another system for printing drafts includes: a second computer having memory and software stored in the memory, the software being configured to enable communicating information corresponding to a draft check with a first computer; wherein the second computer corresponds to a financial institution and the first computer corresponds to a company that is a customer of the financial institution, and the first computer is located at a premises of the company and remotely from the second computer; and wherein the software is configured to enable printing of the draft check by a printer at the premises responsive to communication between the first and second computer.

An embodiment of yet another system for printing drafts includes: means for communicating between a second computer corresponding to a financial institution and a first computer corresponding to a company that has a financial account with the financial institution, wherein the first computer is located at a premises of the company and remotely from the second computer; and means for enabling a draft check to be printed at the premises responsive to the communicating between the first and second computers, wherein the draft check is payable from an account that the company has with the financial institution.

Other systems, methods, features, and advantages of the present invention will be or become apparent to one with skill in the art upon examination of the following drawings and detailed description. It is intended that all such additional systems, methods, features, and advantages be included within this description, be within the scope of the present invention.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram depicting an embodiment of a check printing system.

FIGS. 2-7 are embodiments of screens that are provided to a user by a financial institution server via a company computer.

FIG. 8-13 are flow charts depicting embodiments of methods for printing draft checks.

FIG. 14 depicts an embodiment of a financial institution server.

FIG. 15 depicts an embodiment of a company computer.

### DETAILED DESCRIPTION

In one embodiment, a company having an account at a financial institution uses a computer located at the company's premises to communicate with a remotely located financial institution server to enable the printing of a draft check (hereinafter referred to as a draft) at the company's premises. A printed draft is either MICR-encoded (magnetic ink character recognition encoded) or non-encoded. The company computer includes, for example, an Internet browser that a company employee or agent (hereinafter referred to as a user) uses to communicate with the financial institution server over the Internet. In one implementation, the Internet browser includes browser plug-in software configured to enable secure communication with the financial institution server.

Prior to printing a draft at the company's premises, a company is first authorized by the financial institution to print drafts. After the company is authorized to print drafts, the company then authorizes one or more users to print drafts at the company premises. The financial institution server is updated to reflect that the company and one or more users are authorized to print drafts.

A user uses an Internet browser to select one or more company printers that are available for printing drafts. The user's selection is transmitted to the financial institution server where it is stored. The company also uses the browser to select print settings for printing drafts. The print settings include, for example, identifying a printer, a printer type, a printer tray, and margin lengths. MICR-encoded drafts can be assigned different print settings than non-encoded drafts. For example, MICR-encoded drafts are sent to different printers than non-encoded drafts. The selected print settings are also transmitted to the financial institution server where they are stored.

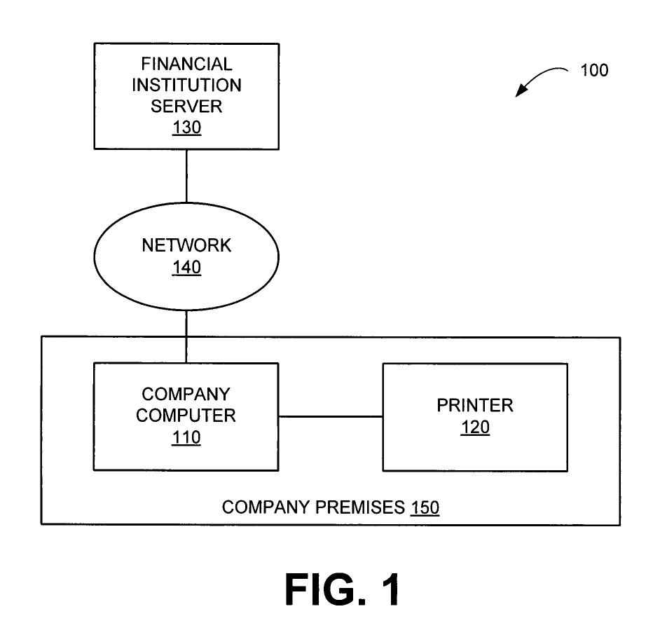

A user uses the Internet browser to select a draft from a list of drafts provided to the browser by the financial institution server. The list of drafts is based on draft information previously provided by the company to the financial institution server (e.g., via a browser). After the user submits the selected draft for printing, the computer transmits draft print data to a printer where the draft is printed. If the user confirms that the draft has been printed successfully, then the financial institution server causes financial institution records to be updated to reflect the printing of the draft. For example, a designated financial institution account is debited in the amount of the draft and/or in the amount of a transaction fee. If the draft printing is not successful, the user can select an option to re-print the draft or to hold the draft for later printing. Various embodiments of the invention will now be described in more detail below with reference to FIGS. 1-15.

FIG. 1 is a block diagram depicting an embodiment of a check printing system 100. The check printing system 100 includes a company computer 110, a printer 120, an financial institution server 130, and a network 140. The company computer 110 and the printer 120 are located at a company premises 150. The company computer 110 is coupled to the financial institution server 130 via the network 140. The network 140 is, for example, a wide area network (WAN) or the Internet.

The financial institution server 130 provides the company computer 110 with images of draft checks to be printed. The printer 120 is used by the company computer 110 to print images of draft checks received from the financial institution server 130. If the network 140 is the Internet, then the company computer 110 includes an Internet browser that is used to communicate with the financial institution server 130. In one implementation, the Internet browser in the company computer 110 includes plug-in software that enables secure communication with the financial institution server 130. The financial institution server 130 transmits, for example, an encrypted image of a draft that is then decrypted by the Internet browser plug-in software operating on the company computer 110.

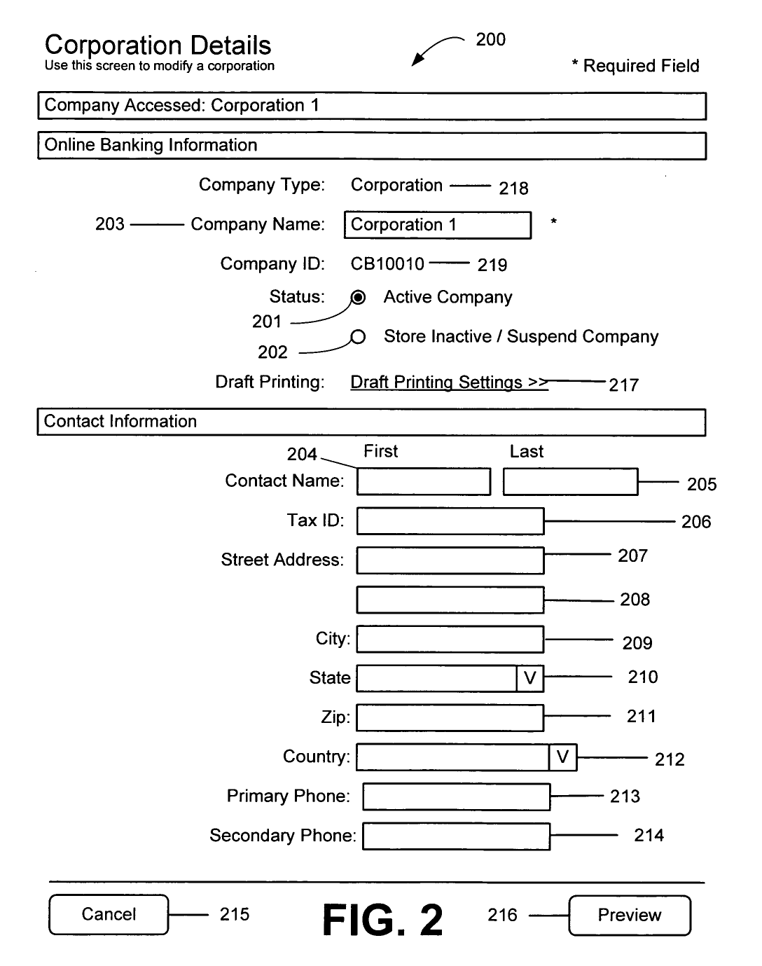

The financial institution server 130 provides the company computer 110 with screens that are used to enable the printing of drafts and the selection of printer-related settings. Examples of these screens are provided in FIGS. 2-7 below. A user can use a desired input device such as, for example, a mouse or a keyboard to select desired printer-related options in respective screens.

FIG. 2 is a schematic diagram depicting a corporation details screen 200 that is provided to a user by the financial institution server 130 via the company computer 110 (FIG. 1). The corporation details screen 200 is used for entering information related to a company that is to be enabled by a financial institution to print drafts. The corporation details screen 200 includes information entry fields 203-214 for receiving respective information. As shown in FIG. 2, the respective information that is received by each of the information entry fields 203-214 includes: company name, first name of a contact person, last name of a contact person, tax identification number (tax ID), first street address, second street address, city, state, zip code, country, primary telephone number (primary phone), and secondary telephone number (secondary phone).

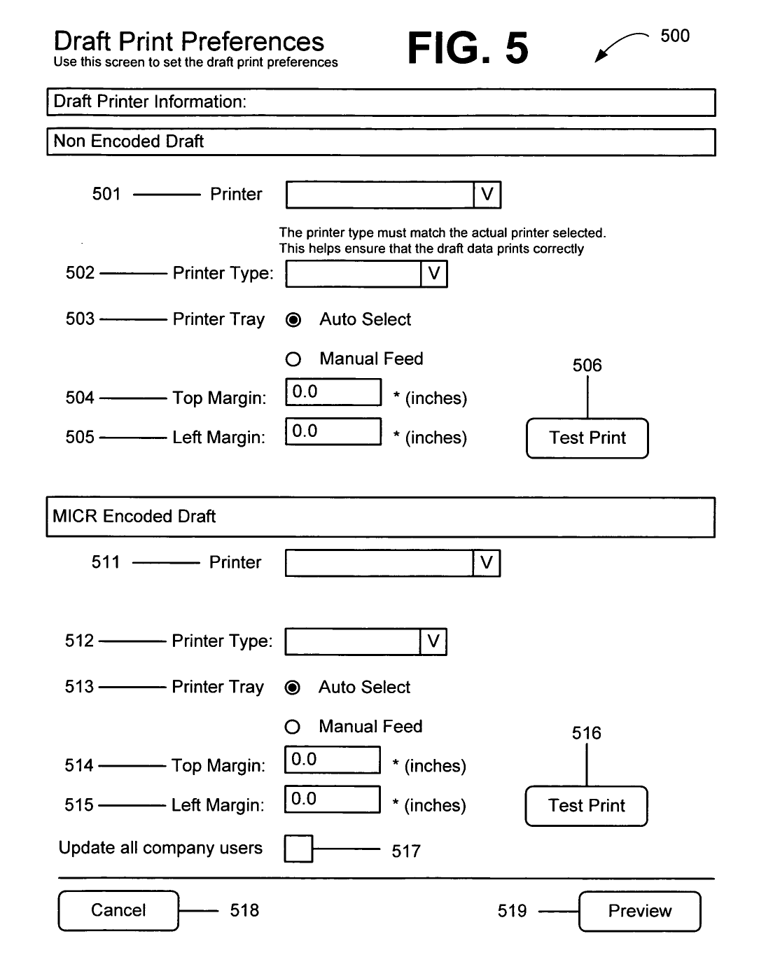

A selection option 201 is used to designate a company's status as active (i.e., authorized to print drafts). A selection option 202, on the other hand, is used to designated the company's status as inactive (i.e., not authorized to print drafts). A hyperlink 217 is used to access another screen (e.g., screen 500, FIG. 5) for entering or modifying draft printing settings.

A cancel button 215 is used to cancel the corporation details screen 200 such that the user is provided with another screen (e.g., a screen presented immediately prior to the corporation details screen 200). A preview button 216 is used to preview the information entered via the corporation details screen 200 prior to submitting the information (e.g., by selecting a subsequently presented ‘submit’ button). After the entered information is submitted, it is transmitted by the customer computer 110 to the financial institution server 130 (FIG. 1) where it is stored.

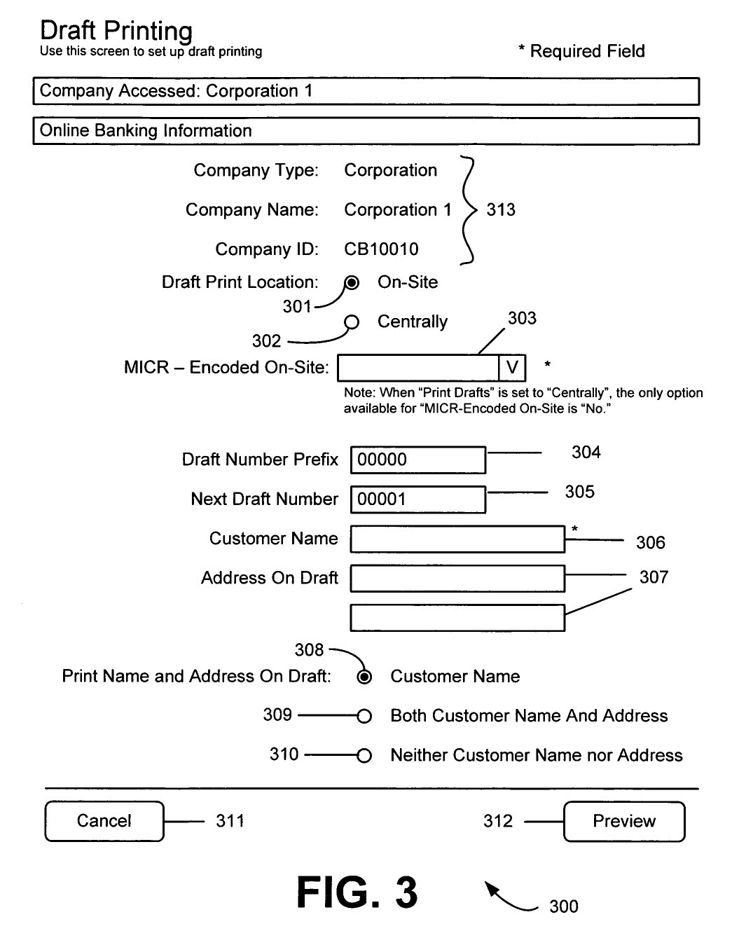

FIG. 3 is a schematic diagram depicting a draft printing set-up screen 300 that is provided to a user by the financial institution server 130 via the company computer 110 (FIG. 1). The draft printing set-up screen 300 includes information entry fields 303-307, selection circles 301-302 and 308-310, and company information 313. The company information 313 identifies the company type, the company name, and the company identification number (ID).

The information entry field 303 is used to select whether MICR-encoded drafts are to be printed on-site. The information entry field 304 is used to enter a draft prefix number, and the information entry field 305 is used to enter the next draft number. The information entry field 306 is used to enter a customer name. The information entry fields 307 are used to enter an address that is to be printed on a draft.

The selection circles 301 and 302 are used to select whether drafts for a company are to be printed on-site (i.e., at the company's premises) or centrally (i.e., at the financial institution). The selection circles 308-310 are used to determine whether a customer name and/or a customer address are to be printed on a draft; the selection circle 308 is selected if the customer name but not the customer address is to printed on a draft, the selection circle 309 is selected if both the customer name and the customer address are to be printed on a draft, and the selection circle 310 is selected if neither customer name nor customer address are to be printed on a draft.

The cancel button 311 is used to cancel the draft printing set-up screen 300. The preview button 312 is used to preview the selections and entries made via the draft printing set-up screen 300 prior to submitting such information and entries (e.g., by selecting a subsequently presented ‘submit’ button). After the entered information is submitted, it is transmitted by the customer computer 110 to the financial institution server 130 (FIG. 1) where it is stored.

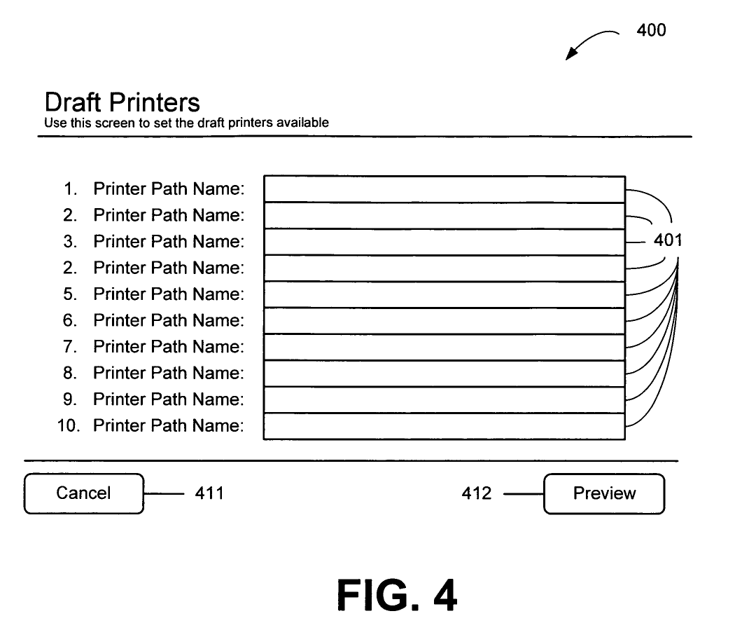

FIG. 4 is a schematic diagram depicting an embodiment of a draft printer selection screen 400 that is provided to a user by the financial institution server 130 via the company computer 110 (FIG. 1). The draft printer selection screen 400 includes a printer path name selection field 401 which can be used to select one or more printers that are to be made available for printing drafts. A user can enter a printer path name in the printer path name selection field 401 for each desired printer. In one implementation, a printer that is not selected for printing drafts via the draft printer selection screen 400 cannot be used for printing drafts.

The cancel button 411 is used to cancel the draft printer selection screen 400. The preview button 412 is used to preview the entries made via the draft printer selection screen 400 prior to submitting such entries (e.g., by selecting a subsequently presented ‘submit’ button). After the entered information is submitted, it is transmitted by the customer computer 110 to the financial institution server 130 (FIG. 1) where it is stored.

FIG. 5 is a schematic diagram depicting an embodiment of a draft print preferences screen 500 that is provided to a user by the financial institution server 130 via the company computer 110 (FIG. 1). The draft print preferences screen 500 includes draft printing options 501-506 corresponding to non-encoded drafts and draft printing options 511-516 corresponding to MICR-encoded drafts.

The following are examples of draft printing options corresponding to printing non-encoded drafts: a printer selection option 501 for selecting a printer, a printer type selection option 502 for selecting a printer type, a printer tray selection option 503 for selecting a printer tray (e.g., auto-select or manual feed), a top margin selection option 504 for selecting a height for a top margin, a left margin selection option 505 for selecting a width for a left margin, and a test print option 506 for initiating a test print according to the selected printer settings.

MICR-encoded drafts have similar printing options which are as follows: a printer selection option 511 for selecting a printer, a printer type selection option 512 for selecting a printer type, a printer tray selection option 513 for selecting a printer tray (e.g., auto-select or manual feed), a top margin selection option 514 for selecting a height for a top margin, a left margin selection option 515 for selecting a width for a left margin, and a test print option 516 for initiating a test print according to the selected printer settings.

Other options provided by the draft print preferences screen 500 include a selection box 517, a cancel option 518, and a preview option 519; the selection box 517 is used to apply the selected draft printer options to all company users, the cancel option 518 is used to cancel the draft print preferences screen, and the preview option 519 is used to preview the selected draft print options prior to submitting them. After the selected draft print options are submitted, they are transmitted by the customer computer 110 to the financial institution server 130 (FIG. 1) where they are stored.

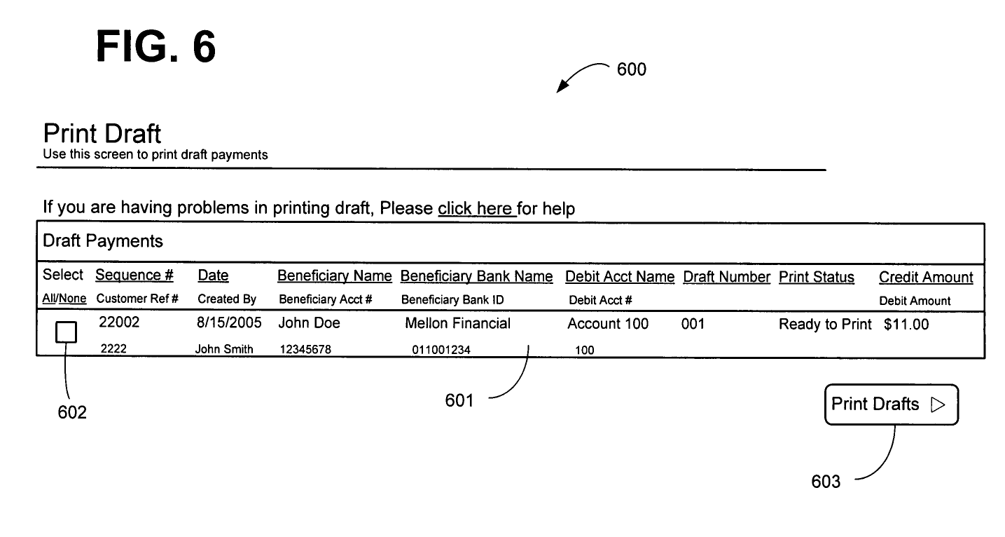

FIG. 6 is a schematic diagram depicting an embodiment of a draft list screen 600 that is provided to a user by the financial institution server 130 via the company computer 110 (FIG. 1). The draft list screen 600 includes a draft details section 601, a draft selection box 602, and a print drafts button 603.

The draft details section 601 includes two rows of information about a draft available for printing. The first row of the draft details section 601 includes the following information: date, beneficiary name, beneficiary bank name, debit account name, draft number, print status, and credit amount (including currency symbol). The second row of the draft details section 601 includes the following information: customer reference number, creator of the draft, beneficiary account number, beneficiary bank identification number, debit account number, and debit amount (including currency symbol). In this example only one draft is listed, although the draft list screen 600 can also be used to list two or more drafts.

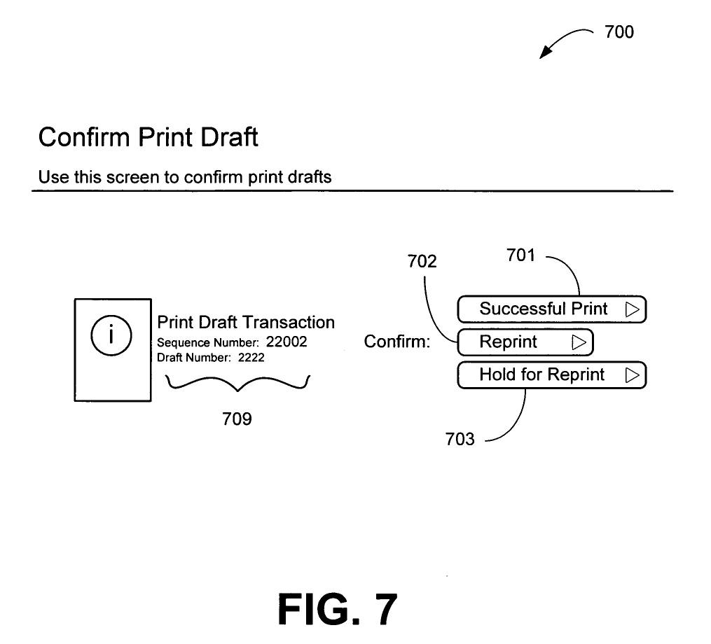

A user reviews the information in the draft details section 601 and then selects a draft to be printed. For example, a user clicks on the draft selection box 602 and then on the print drafts option 603 in order to print a draft described in the draft details section 601. After clicking on the print drafts option 603, the user is presented with a confirm print draft screen 700 (FIG. 7).

FIG. 7 is a schematic diagram depicting an embodiment of a confirm print draft screen 700 that is provided to a user by the financial institution server 130 via the company computer 110 (FIG. 1). The confirm print draft screen 700 is presented to a user after the user selects a draft selection box 602 and then the print drafts option 603 (FIG. 6).

The confirm print draft screen 700 includes at least three selectable options: a successful print option 701, a reprint option 702, and a hold for reprint option 703. A user selects the successful print option 701 if selected draft is successful printed. The user selects the reprint option 702 if the draft printing was not successful and the user wants to reprint the draft at the present time. The user selects the hold for reprint option 703 if the draft printing was not successful and the user wants to hold the draft for printing at a later time. The sequence number and draft number are presented to the user in an information section 709 of the confirm print draft screen 700.

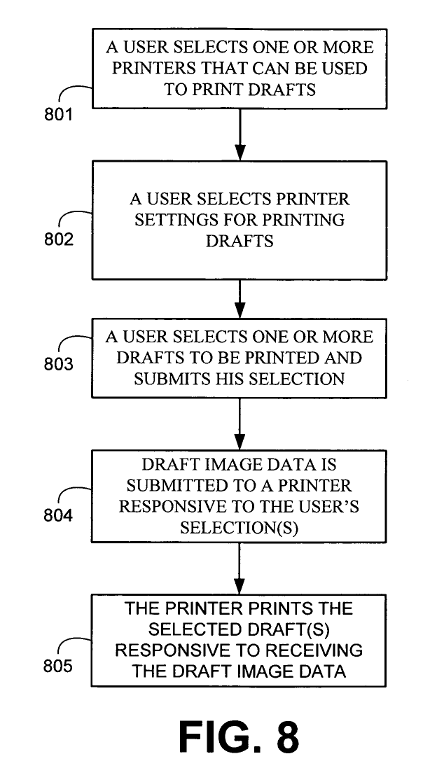

The following FIGS. 8-13 are flow charts depicting examples of methods related to printing drafts at a company premises. FIG. 8 is a flow chart depicting an embodiment of a method 800 comprising steps taken at a company premises for printing drafts. As indicated in step 801, a user selects one or more printers that can be used to print drafts. The user can use, for example, a screen similar to that shown in FIG. 4 to select the printer(s). A user (the same user or another user) then selects printer settings for printing drafts, as indicated in step 802. The printer setting can be selected using, for example, a screen similar to that shown in FIG. 5. A user then selects one or more drafts to be printed and submits his selection, as indicated in step 803. The user can use, for example, a screen similar to that shown in FIG. 6 to select the draft(s) to be printed. In one implementation, the selections made in steps 801-803 are communicated to a financial institution server 130 by the user's computer 110 (FIG. 1). Responsive to a user submitting draft selection(s) in step 803, draft image data is submitted to a printer for printing, as indicated in step 804. The printer then prints the selected draft(s) responsive to receiving the draft image data, as indicated in step 805.

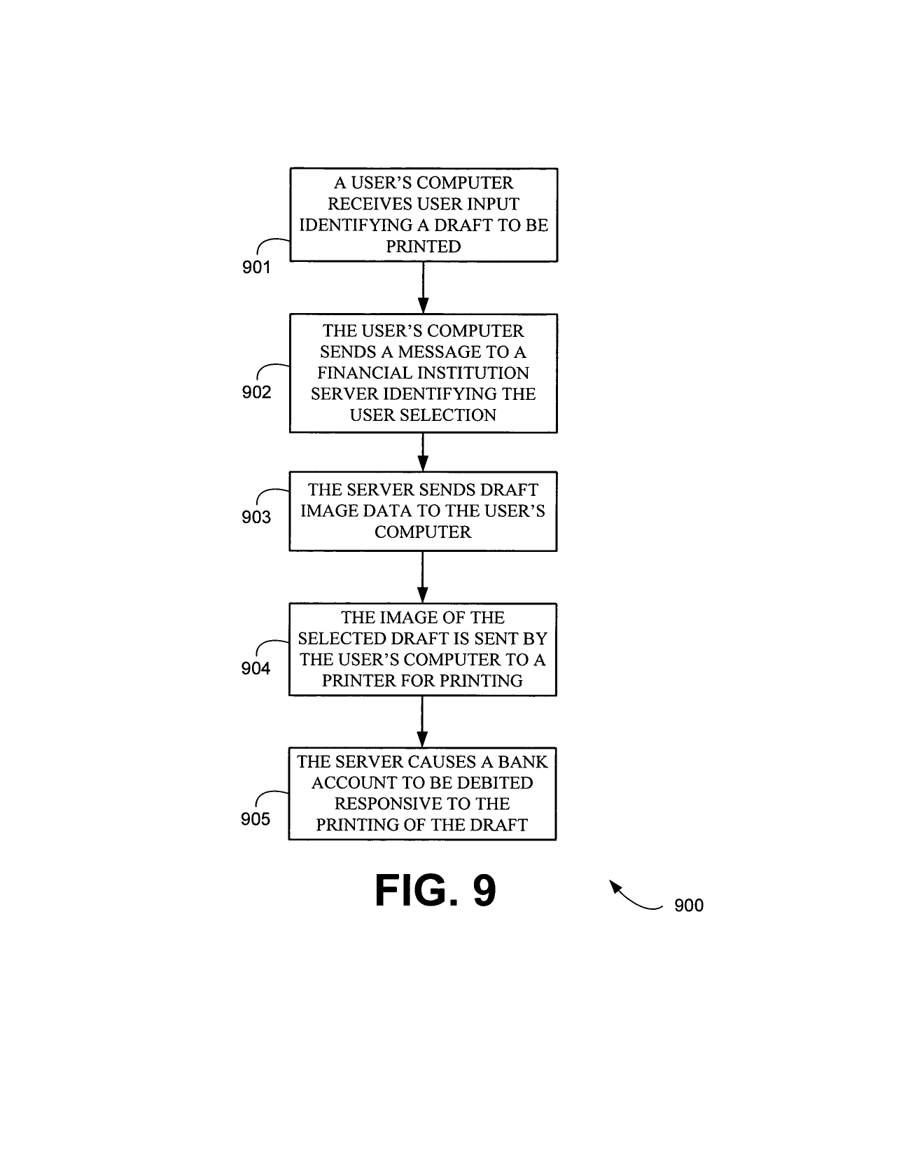

FIG. 9 is a flow chart depicting an embodiment of a method 900 comprising steps taken by a user's computer and an financial institution server in connection with printing a draft. As indicated in step 901, a user's computer receives user input identifying a draft to be printed. Responsive to the user's input, the users computer sends a message to an financial institution server identifying the user selection, as indicated in step 902. The server sends draft image data to the user's computer, as indicated in step 903. In one implementation, the draft image data is encrypted (e.g., scrambled) for security reasons prior to being sent to the user's computer, which then decrypts the draft image. If the financial institution server and the user's computer are communicating via the Internet, then the user's computer can include an Internet browser having plug-in software to enable secure communication.

After the user's computer receives the image data from the server, the user's computer transmits the image data to a printer for printing, as indicated in step 904. After the printer prints the draft encoded by the image data, the server causes a bank account to be debited responsive to the printing of the draft, as indicated in step 905. In one implementation, the bank account is not debited until the user confirms that the draft has been successfully printed and the user's confirmation is sent to the financial institution server by the user's computer.

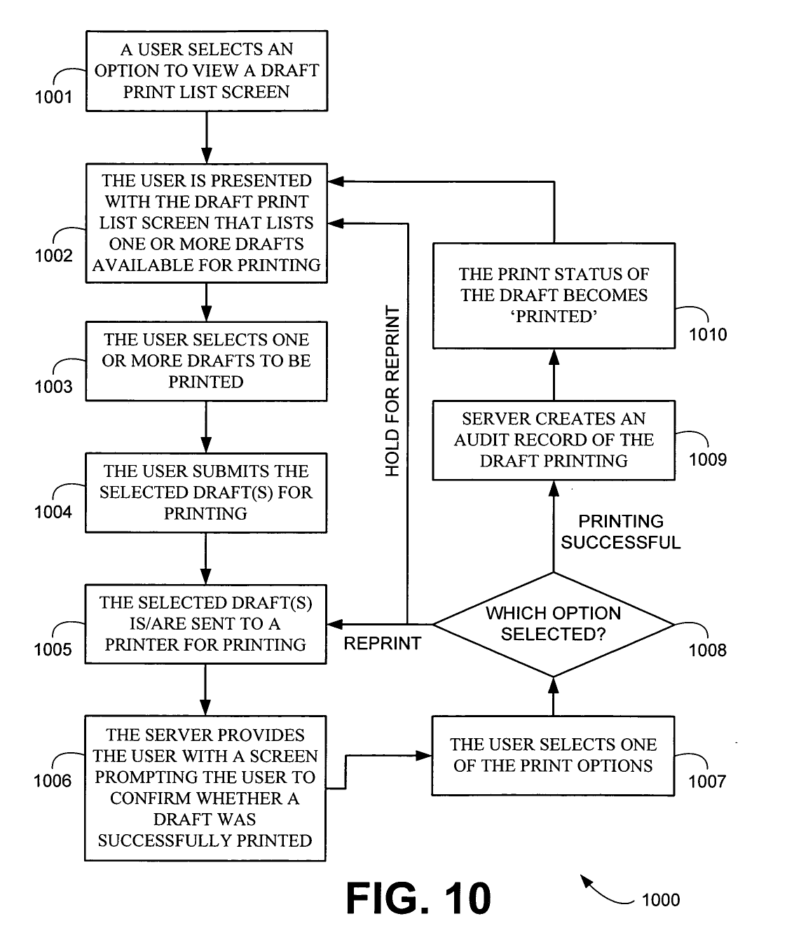

FIG. 10 is a flow chart depicting an embodiment of a method 1000 for printing and/or re-printing a draft. As indicated in step 1001, a user selects an option to view a draft print list screen via a company computer. The company computer is, for example, the company computer 110 (FIG. 1). After selecting the draft print list screen, the user is presented with a draft print list screen that lists one or more drafts available for printing, as indicated in step 1002. The draft list screen is provided, for example, by the financial institution server 130 (FIG. 1) to the company computer 110. In one embodiment, a support person may also view the draft print list screen but is not permitted to print a draft for the user.

The draft list screen includes a list of one or more drafts can be sorted based on date, with the oldest drafts beginning at the top of the screen. In one implementation, some or all the columns of the draft print list screen are sortable. An example of a draft list screen is draft list screen 600 shown in FIG. 6. Although the draft list screen 600 only shows one draft, other draft list screens can include two or more drafts. In one implementation, the user can select an option to view more details pertaining to a particular draft listed in the draft list screen.

After being presented with the draft list screen, the user selects one or more drafts to be printed, as indicated in step 1003. For example, the user can click on selection box 602 in the draft list screen 600. A draft payment that is selected for printing may be one that is designated as being in “reprint,” meaning that a previous print attempt for this draft had failed or that a user did not confirm a successful printing for the draft. If the user is not authorized to print a draft that is a reprint, then the user is not given the option to select a draft in reprint for printing (e.g., the checkbox for the draft is not visible for the user to select and/or the words ‘Not Authorized’ appears next to the draft selection).

After selecting one or more drafts to be printed, the user then submits the selected draft(s) for printing, as indicated in step 1004. For example, the user can click on the print drafts option 603 in the draft list screen 600 (FIG. 6). After the user submits the selected drafts for printing, the selected draft(s) is/are sent to a printer for printing, as indicated in step 1005. The printer is, for example, printer 120 (FIG. 1).

In one implementation, if the company is setup for MICR (magnetic ink character recognition) and the draft is a USD (U.S. dollar) draft, then the draft is sent to a MICR printer (i.e., a printer configured to print MICR drafts). If the company is not setup for MICR and/or the draft is a non-USD then the draft is sent to a non-MICR printer.

After the selected draft(s) is/are sent to the printer for printing, the server provides the user with a screen prompting the user to confirm whether a draft was successfully printed, as indicated in step 1006. In one implementation, the screen provided to the user includes selectable options configured to (a) confirm that the draft printing was successful (a) initiate a reprinting of the draft or (c) hold the draft for reprinting at a later time. An example of a screen prompting the user to confirm whether a draft was successfully printed is shown as the confirm print draft screen 700 in FIG. 7. After the server provides the user with a screen prompting the user to confirm whether a draft was successfully printed, the user selects one of the print options in the screen, as indicated in step 1007.

Responsive to the user selecting one of the print options, the server determines which print option the user has selected, as indicated in step 1008, and provides the user with a screen that is responsive to the user selection. If the user confirms the print as having been successful, then the server proceeds to step 1009 where the server creates an audit record of the draft printing. The audit record contains, for example, the user's log-in ID and details about the printed draft. If a support person had also logged-in to view the draft, then the audit record also contains the support person's login ID.

If the user selects the re-print option, then the server proceeds to step 1005 where the selected draft is re-sent to the printer for printing. If the user selects the ‘Hold for Reprint’ option, then the user is returned to the draft print list screen (step 1002) and the status of the draft now becomes ‘re-print.’ If the user does not make a selection within a pre-determined time period, then the status of the draft also becomes re-print and the user is returned to the draft print list screen.

After an audit record of the draft printing is created, the print status of the draft becomes ‘printed’, as indicated in step 1010, and the user is returned to step 1002 where the user is presented with a draft print list screen that no longer lists the successfully printed draft.

In one embodiment, some or all of the following may be required to print a draft: the company is granted access to a draft by the financial institution; the company has at least one account that has been enabled by the financial institution to make draft payments; the company has been authorized to perform ‘on-site’ draft printing; the user seeking to print a draft has been authorized to do so (e.g., by a company server administrator); the user has been authorized to access at least one internet-enabled internal account; the printer set-up has been properly completed; there is at least one draft available for printing (e.g., listed on a draft print list screen); the draft is in a ‘confirmed’ status, and therefore appears on the draft print list screen.

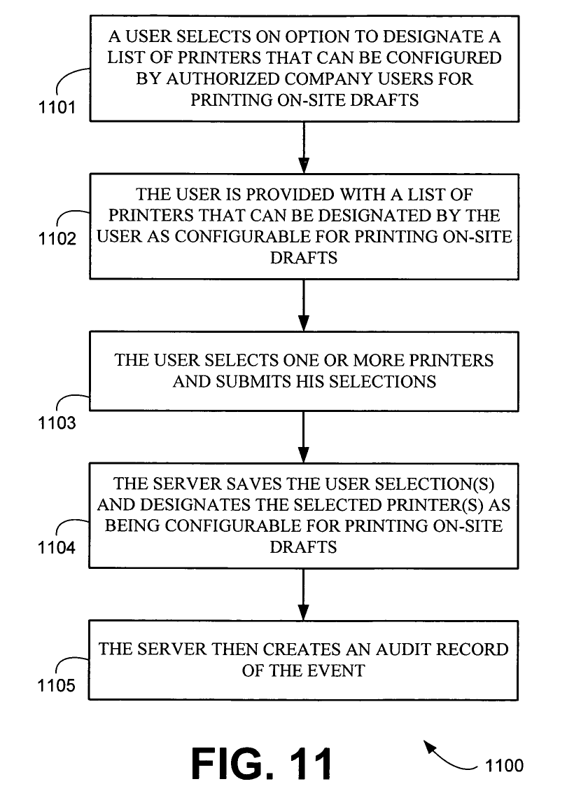

FIG. 11 is a flow chart depicting a method 1100 for designating printers that are configurable by authorized company users for printing on-site drafts. The method 1100 begins with step 1101 where a user selects on option to designate a list of printers that can be configured by authorized company users for printing on-site drafts. In response to the user selection, the user is provided with a list of printers that can be designated by the user as configurable for printing on-site drafts, as indicated in step 1102. The list of printers available for selection depends, for example, on the printers for which the user has access (e.g., local or network access).

After being provided with a list of printer, the user selects one or more printers and submits his selection(s), as indicated in step 1103. In one implementation, if the user selects ‘none’ from the list of available printers and submits the selection, then no printers are designated as printers that are configurable for printing on-site drafts. Furthermore, prior to selecting one or more printers, a user may choose to cancel the process of selecting printers, in which case the list of printers is removed and the user is, for example, returned to a prior screen. After the user selects one or more printers and submits his selection(s), the server saves the user selection(s) and designates the selected printer(s) (if any) as being configurable for printing on-site drafts, as indicated in step 1104. The server then creates an audit record of event, as indicated in step 1105. The audit record identifies, for example, the user and the action taken by the user. The printers that are selected as being configurable for printing on-site drafts can thereafter be configured by authorized company users to print on-site drafts.

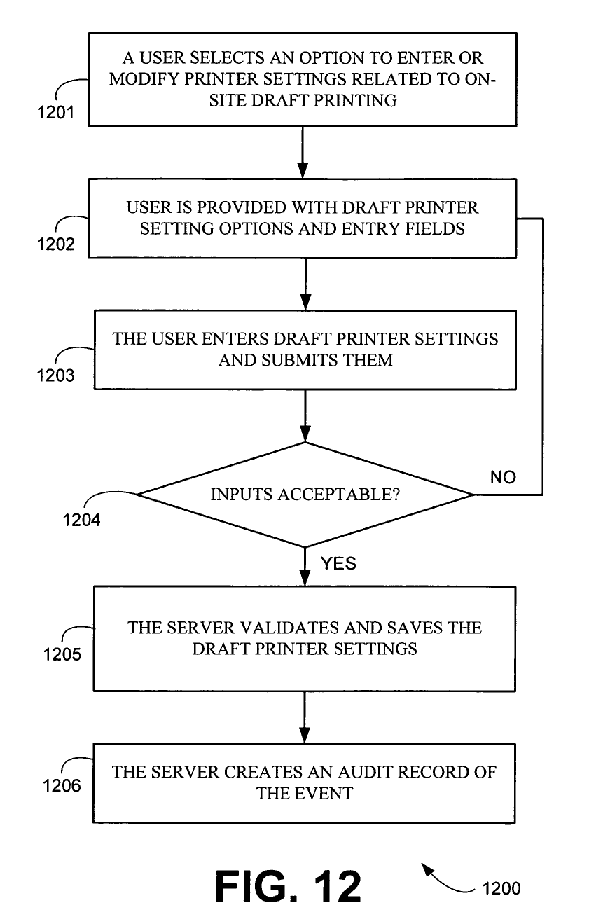

FIG. 12 is a flow chart depicting an embodiment of a method 1200 for determining printer settings for draft printing. A user selects an option to enter or modify printer settings related to on-site draft printing, as indicated in step 1201. Then in step 1202, the user is provided with draft printer options and entry fields. For example, in one implementation, among others, the user is provided with the draft print preferences screen 500 shown in FIG. 5.

The draft printer options provided include, for example (1) an option to update the draft printer settings, (2) an option to initiate a test print, and (3) an option to submit the draft printer settings. The user is also provided, for example, with entry fields for providing the following information: an identification of the specific printer to be used by the current user for printing a draft; the paper feed method to be used for the printer (e.g., auto select (default) or manual feed); the top margin (e.g., in inches) for printed drafts (default is, for example, 0.0 inches); the left margin (e.g., in inches) for printed drafts (default is, for example, 0.0 inches).

A list of printers available for printing is based on the printers previously designated as being available for draft printing and/or on printers that the user's computer is coupled to via a local or wide-area network.

After the user is provided with the printer-related options and entry fields, the user enters draft printer settings and submits them (e.g., by selecting a ‘submit’ option), as indicated in step 1203. The user can choose to apply the specified draft printer settings to all users of the company by selecting a corresponding option (e.g., by clicking on selection box 517 (FIG. 5). Prior to submitting the draft printer settings, the user can cancel the process of specifying draft printer settings (e.g., by selecting a ‘cancel’ option).

Responsive to the user submitting the draft printer settings, the server verifies whether the user inputs are acceptable (e.g., whether required fields have been filled and the entered data meet format requirements), as indicated in step 1204. If the user inputs are not acceptable, the server displays an error message (e.g., configurable by the financial institution) that describes the verification failure and returns the user to step 1202 so that the problem can be corrected.

If the required fields have been filled and the entered data meet format requirements, then the server validates and saves the draft printer settings (either for the current user or for all users, depending on a corresponding user selection), as indicated in step 1205.

The following table lists examples of required attributes for the printer setting inputs to be successfully validated:

TABLE 1
attributes for printer setting inputs

| | User-Input | | Maximum |
|---|---|---|---|
| Field Name | Requirement | Data Type | Length |
| Printer | mandatory | alphanumeric | none |
| Paper tray | mandatory | character | none |
| Top margin | mandatory | numeric | four digits |
| Left margin | mandatory | numeric | four digits |

After the server validates and saves the printer settings, the server then creates an audit record of the event, as indicated in step 1206. The audit record identifies, for example, the user and the action taken by the user.

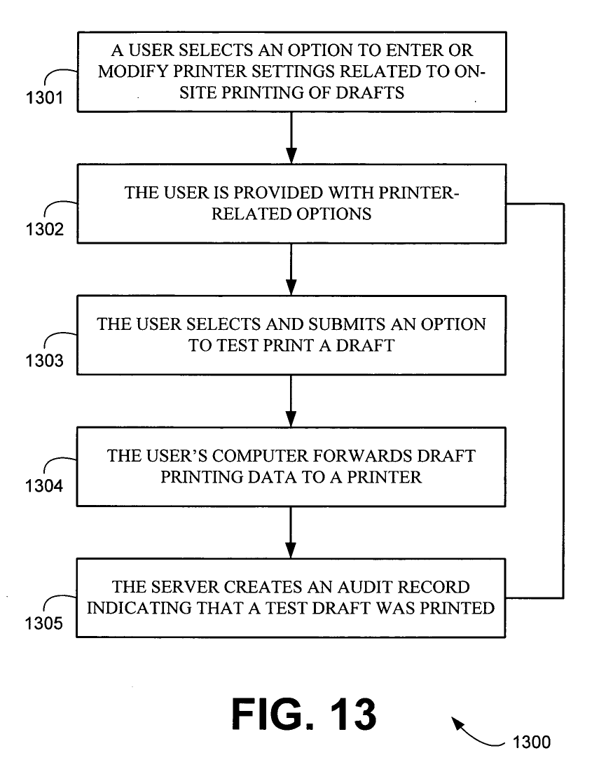

FIG. 13 is a flow chart depicting an embodiment of a method 1300 for test-printing a draft. The method begins at step 1301 where a user selects on option to enter or modify printer settings related to on-site printing of drafts. Then in step 1302, the user is provided with the following printer-related options: (1) update the draft printer settings, (2) initiate a test print, and (3) submit the draft printer settings. By selecting the option to initiate a test print, the user is able to print an MICR-encoded or a non-encoded draft, based on the user's draft printer settings. In one implementation, test printing of drafts is available when the server draft printing software setting for ‘print drafts’ is set to ‘on-site’. Furthermore, test printing of encoded drafts is available when the server draft printing software setting for encoded drafts ‘on-site’ is specified as ‘test’ or ‘production.’

After the user is provided with the printer-related options, the user selects and submits an option to test-print a draft, as indicated in step 1303. Then responsive to the user's selection, the user's computer forwards draft printing data to a printer where the printer test-prints a draft, as indicated in step 1304. After printing the test draft, the server creates an audit record indicating that a test draft was printed, as indicated in step 1305. The method 1300 then returns to step 1302 where the user is presented with printer related options.

A test-printed draft tests the user's draft printer settings to see if they are acceptable. The tested draft printer settings relate to identifying a printer, a paper feed method, a top margin, and a bottom margin. After a test print, the user may modify the print settings and re-initiate a test print. Modified draft printer settings are not saved in long-term memory until submitted by the user and validated by the server.

A customer name and address printed on a non-encoded test draft are retrieved from the company's draft printing settings in the server draft printing software. In addition, the company's draft printing settings contain a setting which determines what should be displayed on the drafts. The options include (a) neither customer name nor address (b) both customer name and address or (c) customer name.

In one implementation, a test-printed non-encoded draft does not contain any payment information. The lines and boxes in the non-encoded test draft are left blank. The word “void” is displayed in large font across a top portion of the non-encoded test draft. Furthermore, no check number is printed on the non-encoded test draft.

In one implementation for printing an MICR-encoded draft, a customer's 7 digit ‘draft number prefix’ is retrieved from the company's draft printing settings in the server draft printing software and displayed on the test MICR-encoded draft. The “draft number prefix” is displayed in both the “cheque no.” portion of the draft, and in the MICR line. Furthermore, a draft number of ‘00000’ is printed on the test MICR-encoded draft in both the “cheque no.” Portion of the draft, and in the MICR line.

Furthermore, a MICR-encoded draft includes a drawee bank routing number and account number (which are retrieved from a properties file) and displayed in a MICR line of the test draft. Example default values for printing a MICR-encoded draft are ‘123456789’ for the drawee bank routing number, and ‘777788889999’ for the drawee bank account number.

The MICR line includes a customer's 7 digit draft number prefix followed by five zeros (00000), a single space, a drawee's bank routing number, a single space, and a drawee's bank account number. An example of a MICR line's contents is: 7555500000 143456789 1377788889999.

Any process descriptions or blocks in the flow charts should be understood as representing modules, segments, or portions of code which include one or more executable instructions for implementing specific logical functions or steps in the process. Alternative implementations are included within the scope of the embodiments of the invention in which functions are executed out of order from that shown or discussed, including substantially concurrently or in reverse order, depending on the functionality involved, as would be understood by those reasonably skilled in the art of the present invention.

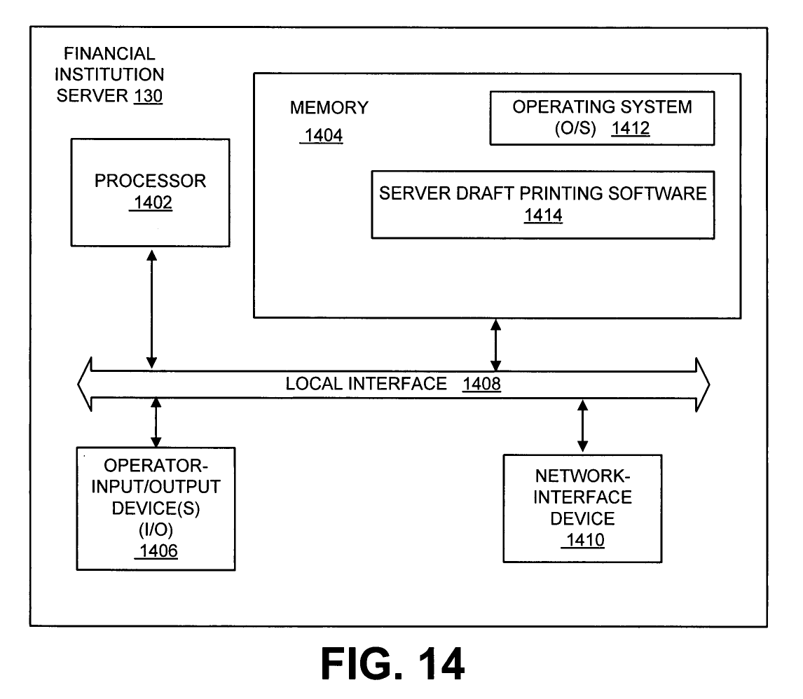

FIG. 14 is a block diagram illustrating an embodiment of an financial institution server 130. The financial institution server 130 includes a processor 1402, memory 1404 and one or more user input and/or output (I/O) device(s) 1406 (or peripherals) that are communicatively coupled via a local interface 1408.

The local interface 1408 can be, for example but is not limited to, one or more buses or other wired or wireless connections, as is known in the art. The local interface 1408 might have additional elements, which are omitted for simplicity, such as controllers, buffers (caches), drivers, repeaters, and receivers, to enable communications. Further, the local interface 1408 might include address, control, and/or data connections to enable appropriate communications among the aforementioned components.

The processor 1402 is a hardware device for executing software, particularly that stored in memory 1404. The processor 1402 can be any custom made or commercially available processor, a central processing unit (CPU), an auxiliary processor among several processors associated with the underwriter system, a semiconductor based microprocessor (in the form of a microchip or chip set), or generally any device for executing software instructions.

The memory 1404 can include any one or combination of volatile memory elements (e.g., RAM, such as DRAM, SRAM, SDRAM, etc.) and nonvolatile memory elements (e.g., ROM, flash memory, etc.). Moreover, the memory 1404 might incorporate electronic, magnetic, optical, and/or other types of storage media. Note that the memory 1404 can have a distributed architecture, where various components are situated remote from one another, but can be accessed by the processor 1402.

The user I/O device(s) 1406 include input devices such as, for example but not limited to, a keyboard, mouse, scanner, microphone, a touch sensitive display etc. Furthermore, the user I/O device(s) 1406 also include output devices such as, for example but not limited to, a printer, display, etc. The network interface device(s) 1410 include, for example, a modem, a radio frequency (RF) or other transceiver, a telephonic interface, an Ethernet interface, a bridge, and/or a router.

Software stored in memory 1404 may include one or more separate programs, each one of which comprises an ordered listing of executable instructions for implementing logical functions. In the example of FIG. 14, the software in the memory 1404 includes operating system 1412 and server draft printing software 1414. Among other things, the operating system 1412 essentially controls the execution of the server draft printing software 1414 and provides scheduling, input-output control, file and data management, memory management, and communication control and related services. The server draft printing software 1414 is used by the financial institution server 130 to communicate with a customer computer 110 via the network 140 (FIG. 1) and to enable the customer computer 110 to print a draft via the printer 120. The draft printing software also communicates with other financial institution software to cause a bank account to be debited responsive to the printing of a draft by the printer 120.

The server draft printing software 1414 is a source program, executable program (object code), script, or any other entity comprising a set of instructions to be performed. When implemented as a source program, the server draft printing software 1414 is translated via a compiler, assembler, interpreter, or the like, which may or may not be included within the memory 1404, so as to operate properly in connection with the O/S 1412. Furthermore, the server draft printing software 1414 can be written in one or more object oriented programming languages, which have classes of data and methods, or procedure programming languages, which have routines, subroutines, and/or functions.

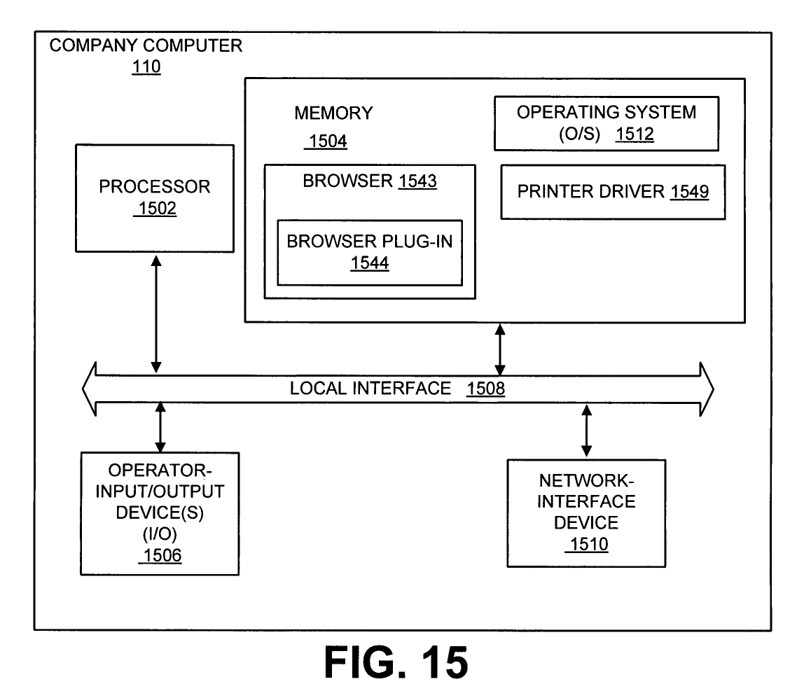

FIG. 15 is a block diagram illustrating an embodiment of a company computer 110 (FIG. 1). The company computer 110 includes a processor 1502, memory 1504 and one or more user input and/or output (I/O) device(s) 1506 (or peripherals) that are communicatively coupled via a local interface 1508.

The local interface 1508 can be, for example but is not limited to, one or more buses or other wired or wireless connections, as is known in the art. The local interface 1508 might have additional elements, which are omitted for simplicity, such as controllers, buffers (caches), drivers, repeaters, and receivers, to enable communications. Further, the local interface 1508 might include address, control, and/or data connections to enable appropriate communications among the aforementioned components.

The processor 1502 is a hardware device for executing software, particularly that stored in memory 1504. The processor 1502 can be any custom made or commercially available processor, a central processing unit (CPU), an auxiliary processor among several processors associated with the underwriter system, a semiconductor based microprocessor (in the form of a microchip or chip set), or generally any device for executing software instructions.

The memory 1504 can include any one or combination of volatile memory elements (e.g., RAM, such as DRAM, SRAM, SDRAM, etc.) and nonvolatile memory elements (e.g., ROM, flash memory, etc.). Moreover, the memory 1504 might incorporate electronic, magnetic, optical, and/or other types of storage media. Note that the memory 1504 can have a distributed architecture, where various components are situated remote from one another, but can be accessed by the processor 1502.

The user I/O device(s) 1506 include input devices such as, for example but not limited to, a keyboard, mouse, scanner, microphone, a touch sensitive display etc. Furthermore, the user I/O device(s) 1506 also include output devices such as, for example but not limited to, a printer, display, etc. The network interface device(s) 1510 include, for example, a modem, a radio frequency (RF) or other transceiver, a telephonic interface, an Ethernet interface, a bridge, and/or a router.

Software stored in memory 1504 may include one or more separate programs, each one of which comprises an ordered listing of executable instructions for implementing logical functions. In the example of FIG. 15, the software in the memory 1504 includes an operating system 1512, a browser 1543, and a printer driver 1549. Among other things, the operating system 1512 essentially controls the execution of other software in memory 1504 and provides scheduling, input-output control, file and data management, memory management, and communication control and related services.

The browser 1543 is used by the customer computer 110 to communicate with an financial institution server 130 via a network 140 (FIG. 1). The browser 1543 and the financial institution server 130 communicate information related to the printing of drafts at the customer premises 150 (FIG. 1). The printer driver 1549 communicates with a printer 120 (FIG. 1) located at the company premises 150 to enable the printing of a draft.

The browser plug-in software 1544 is configured to enable secure communication with the financial institution server 130. For example, the browser plug-in software 1544 may be configured to decrypt or descramble images of drafts received from the financial institution server 130.

The browser 1543 and printer driver 1549 are source programs, executable programs (object code), scripts, or any other entities comprising sets of instructions to be performed. When implemented as source programs, the browser 1543 and printer driver 1549 are translated via a compiler, assembler, interpreter, or the like, which may or may not be included within the memory 1504, so as to operate properly in connection with the O/S 1512. Furthermore, the browser 1543 and printer driver 1549 can be written in one or more object oriented programming languages, which have classes of data and methods, or procedure programming languages, which have routines, subroutines, and/or functions.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method comprising:
communicating between a second computer corresponding to a financial institution and a first computer corresponding to a company that has a financial account with the financial institution, wherein the first computer is located at the company's premises and remotely from the second computer; and
printing a draft check by a printer that is coupled to the first computer responsive to the communicating between the first and second computers, wherein the draft check is payable from a financial account that the company has with the financial institution.

2. The method of claim 1, further comprising causing the account of the company to be debited responsive to the second computer receiving confirmation from the first computer that the draft check was printed.

3. The method of claim 1, further comprising transmitting print settings corresponding to the printer from the first computer to the second computer, wherein the draft is printed in accordance with the print settings.

4. The method of claim 1, further comprising transmitting print settings corresponding to the printer from the second computer to the first computer, wherein the draft is printed in accordance with the print settings.

5. The method of claim 1, further comprising transmitting by the second computer image data corresponding to the draft check to the first computer, wherein the image data enables the draft check to be printed by the printer.

6. The method of claim 5, further comprising decrypting the image data by the first computer, wherein the image data transmitted by the second computer to the first computer is encrypted.

7. The method of claim 1, wherein the first computer and the second computer communicate via the Internet, and wherein the first computer includes Internet browser plug-in software configured to enable secure data transmission from the second computer to the first computer.

8. The method of claim 1, further comprising transmitting from the first computer to the second computer a list of printers designated for printing draft checks, wherein the printer is identified in the list of printers.

9. A system comprising:
a first computer having memory and software stored in the memory, the software being configured to enable communicating information corresponding to a draft check with a second computer;
wherein the second computer corresponds to a financial institution and the first computer corresponds to a company that is a customer of the financial institution, and the first computer is located at a premises of the company and remotely from the second computer; and
wherein the software is configured to enable printing of the draft check by a printer at the premises responsive to communication between the first and second computers.

10. The system of claim 9, wherein the draft check is MICR encoded and the printer is configured to print MICR documents.

11. The system of claim 9, wherein the second computer is configured to cause an account of the company at the financial institution to be debited at least in the amount of the draft check responsive to the second computer receiving confirmation from the first computer that the draft check has been printed.

12. The system of claim 9, wherein the second computer is configured to transmit image data corresponding to the draft check to the first computer, and wherein content of the draft check that is printed is responsive to the image data.

13. The system of claim 9, wherein the first computer uses an internet browser to communicate with the second computer via the Internet.

14. A system comprising:
a second computer having memory and software stored in the memory, the software being configured to enable communicating information corresponding to a draft check with a first computer;
wherein the second computer corresponds to a financial institution and the first computer corresponds to a company that is a customer of the financial institution, and the first computer is located at a premises of the company and remotely from the second computer; and
wherein the software is configured to enable printing of the draft check by a printer at the premises responsive to communication between the first and second computer.

15. The system of claim 14, wherein the draft check is MICR encoded and the printer is configured to print MICR documents.

16. The system of claim 14, wherein the software is configured to cause an account of the company at financial institution to be debited at least in the amount of the draft check responsive to second computer receiving confirmation from the first computer that the draft check has been printed.

17. The system of claim 14, wherein the second computer is configured to transmit image data corresponding to the draft check to the first computer and wherein content of the printed draft check that is printed is responsive to the image data.

18. The system of claim 14, wherein the first computer uses an internet browser to communicate with the second computer via the Internet.

19. A system comprising:
means for communicating between a second computer corresponding to a financial institution and a first computer corresponding to a company that has a financial account with the financial institution, wherein the first computer is located at a premises of the company and remotely from the second computer; and
means for enabling a draft check to be printed at the premises responsive to the communicating between the first and second computers, wherein the draft check is payable from an account that the company has with the financial institution.

20. The system of claim 19, further comprising:
means for enabling the financial account to be debited responsive to the second computer receiving confirmation from the first computer indicating that the check has been printed.

21. The system of claim 19, wherein the content of the draft check that is printed is responsive to draft check image data received by the first computer from the second computer.
